(19) United States
(12) Patent Application Publication
(10) Pub. No.: US 2002/0128860 A1
(43) Pub. Date: Sep. 12, 2002

(54) Collecting and managing clinical information

(76) Inventors: Joseph A. Leveque, Altadena, CA (US); Lori Dolan Frymark, Pasadena, CA (US); Douglas D. Lind, New York, NY (US)

Correspondence Address: SHEARMAN & STERLING, INTELLECTUAL PROPERTY DOCKETING, 599 LEXINGTON AVENUE, NEW YORK, NY, 10022, US

(21) Appl. No.: 09/754,743

(22) Filed: Jan. 4, 2001

(51) Int. Cl. G06F 17/60

(52) U.S. Cl. 705/2

(57) ABSTRACT

The present system includes the aggregation, anonymization, analysis, and dissemination of information including susceptibility, progression, severity of disease, the resources utilized to treat those diseases, quality of life of patients who have those diseases, ability to participate in the workforce and, ultimately, survival. This information, when analyzed for patients along with relatives of those patients, provides an understanding of why genetically similar or identical patients express diseases differently. Collecting the information and linking that information to genotypic information provides a determination of role the genetic makeup of an individual plays in disease contraction, treatment and outcome.

### BACKGROUND

The present invention relates to a system for collecting, managing, analyzing and reporting information relating to clinical, economic and/or epidemiological outcomes.

It has been known to develop and manage databases containing clinical outcomes related to medical information collected from cancer patients. It has also been known to develop economic databases to compare treatment costs between certain diseases and between certain hospitals, on both the inpatient side and on the outpatient side, where the primary focus has been on physician professional services in the outpatient setting.

In addition, several other private and public institutions have been in the business of developing epidemiological databases. It has been known to develop a longitudinal database around coronary artery disease where a study was conducted over the course of many decades to track people who had a known risk for coronary artery disease. As time progressed, new risk factors were identified and incorporated into the database and the ultimate outcomes of those patients were tracked. Individual patients were tracked and information was recorded from the time the patient was diagnosed to the time the patient died. Additionally, all incidental complications were tracked and recorded, for example, such as whether or not they died from a complication related to their heart disease.

There are other cancer-related databases that are being developed either in the private sector or through private sponsorships. A pilot study is currently in progress for breast cancer and lymphoma to collect clinical and economic outcomes at numerous hospitals. It has been known that the use of the data is primarily to evaluate the adherence to certain guidelines to determine if the effects on the quality of care.

Typically, information for such longitudinal medical studies similar to those mentioned above typically is gathered through written survey forms where people are either contacted on the phone, visit a doctor, and at the time of that visit or at the time that phone conversation the data was collected in a direct fashion using a written survey.

### SUMMARY

In general, in a first aspect, the invention features method for processing medical information which may include gathering longitudinal medical information of a patient and aggregating and anonymizing the longitudinal medical information into selected categories incident to a particular disease.

In general, in a second aspect, the invention features a method for processing medical information of a patient which may include gathering longitudinal medical information of patients from at least one hospital in order to determine phenotype information and communicating the longitudinal information in an aggregated and anonymized format to the at least one hospital.

In general, in a third aspect, the invention features a method for processing medical information which may include gathering longitudinal medical information of a patient and from at least one relative of the patient from at least one hospital where such longitudinal medical information is collected and managed and communicating the longitudinal medical information in an aggregated and anonymized format to at least one hospital.

In general, in a fourth aspect, the invention features a method for correlating longitudinal medical information of a patient afflicted with disease which may include gathering longitudinal medical information of the patient afflicted with disease and from relatives of the patient from at least one hospital where such longitudinal medical information is collected, determining phenotype information from the gathered longitudinal information, and communicating the longitudinal information aggregated and anonymized to at least one hospital.

In general, in a fifth aspect, the invention features a method for correlating longitudinal medical information of at least one patient afflicted with disease which may include gathering longitudinal medical information from each one of at least one patient afflicted with disease and from relatives of each one of the at least one patient from at least one hospital where such longitudinal medical information is collected to determine phenotype information, anonymizing the longitudinal information, storing the longitudinal information on a database accessible to at least one hospital, and communicating the longitudinal information aggregated and anonymized to at least one hospital.

In general, in a sixth aspect, the invention features a method for processing longitudinal medical information of at least one patient afflicted with disease which may include collecting longitudinal medical information from each patient as each one progresses through a diagnostic, a treatment and a follow-up stage of the disease, anonymizing the longitudinal medical information, and storing the longitudinal information on a database accessible by at third party user.

In general, in a seventh aspect, the invention features a method for processing longitudinal medical information of at least one patient afflicted with disease which may include gathering longitudinal medical information from a medical institution where such longitudinal medical information may be collected and managed, aggregating the longitudinal medical information, anonymizing the longitudinal medical information, and storing the longitudinal medical information in a database accessible by at least one hospital.

In general, in an eighth aspect, the invention features a method for processing longitudinal medical information of at least one patient afflicted with disease which may include gathering longitudinal medical information from at least one hospital where such longitudinal medical information is collected and managed, aggregating the longitudinal medical information, anonymizing the longitudinal information, determining phenotypic information from the longitudinal medical information, and storing both the longitudinal information and the phenotypic information in at least one database accessible by at least one hospital.

In general, in a ninth aspect, the invention features a method which may include gathering longitudinal medical information from at least one patient afflicted with disease and from relatives of each one of the at least one patient, and communicating the longitudinal information in an aggregated and anonymized format to at least one hospital.

In general, in a tenth aspect, the invention features a method for determining phenotype information which may include gathering longitudinal medical information of at least one patient from at least one hospital where such longitudinal medical information is collected, aggregating the longitudinal medical information, anonymizing the longitudinal medical information, comparing the longitudinal information gathered from each one of at least one patient with pre-determined genetic data ascertained from both each one of at least one patient and at least one relative of each one of at least one patient, determining a phenotypic expression of the comparison, and storing the longitudinal information and the phenotypic expression in a database accessible by at least one hospital.

In general, in an eleventh aspect, the invention features a method for determining a correlation between genetic predispositions and phenotype information in order to successfully treat disease which may include correlating longitudinal medical information gathered from at least one hospital where such longitudinal medical information is collected where the longitudinal information being collected from at least one patient having a disease and at least one relative of each one of the at least one patient, aggregating the longitudinal medical information, anonymizing the longitudinal medical information, and storing the longitudinal information in a database accessible by each one of the at least one hospital.

Preferred embodiments of the invention may include one or more of the following features. Particular embodiments of the invention may feature one or more of the following advantages including generating information such as disease susceptibility, severity, progression, quality of life, workforce participation, productivity and morbidity.

Particular embodiments of the invention may feature one or more of the following advantages including identifying genes that may predispose people to cancer whose pathways of action are associated with documented and previously unknown environmental carcinogens and lifestyle exposures, quantifying risk resulting from environmental carcinogens and lifestyle exposures, or integrating information on disease susceptibility and environmental carcinogens and lifestyle exposures in order to estimate cancer risks for individuals, families and populations.

In general, in a twelfth aspect, the invention features a method for doing business which may include providing computer hardware to a medical institution at less than market price, in return for access to patient data generated at the medical institution.

Particular embodiments of the invention may feature selling or offering for sale the patient data available in an anonymized form to customers outside the medical institution.

In general, in a thirteenth aspect, the invention features a method which may include aggregating patient data drawn from multiple incompatible databases into a single database in an anonymized form, and providing access to the single database to a user.

In general, in a fourteenth aspect, the invention features system for managing clinical information including a first database for storing patient data, a computer interconnected to the first database, where the computer is programmed to anonymize and aggregate the patient data, and a second database interconnected to the computer, where the second database for storing the anonymized and aggregated the patient data.

Particular embodiments of the invention may feature one or more of the following advantages including where the first database includes information in the group consisting of genetic profile, disease susceptibility, severity, and progression, where the second database includes information in the group consisting of quality of life, workforce participation, productivity and morbidity, where the computer may be programmed to identifying genes that may predispose people to cancer whose pathways of action are associated with documented and previously unknown environmental carcinogens and lifestyle exposures or where the computer is programmed to determine a phenotypic expression of the patient data.

In general, in a fifteenth aspect, the invention features a system for determining a phenotypic expression of a patient having a genetic predisposition for disease, which may include at least one hospital having a first database for storing local disease outcomes information, a vendor having a second database, where the second database may be interconnected to the first database, the second database for storing patient data collected from the at least one hospital, and a computer programmed to anonymize and aggregate the patient data, where the second database is accessible by third party users.

The above advantages and features are of representative embodiments only, and are presented only to assist in understanding the invention. It should be understood that they are not to be considered limitations on the invention as defined by the claims, or limitations on equivalents to the claims. Additional features and advantages of the invention will become apparent in the following description, from the drawings, and from the claims.

### BRIEF DESCRIPTION OF THE DRAWINGS

In the drawings, which illustrate, in a non-limiting fashion, the best mode presently contemplated for carrying out the present invention:

FIG. 1 is a block diagram;

FIG. 2 is a flow chart;

FIGS. 3a-3e are flow charts of FIG. 2 in detail at various stages;

FIG. 4 is a flow chart of information flow;

FIGS. 5a-5e are flow charts of alternative embodiments of the system described in FIG. 4; and

FIGS. 6a-6c shows various forms used to collect medical information.

### DESCRIPTION

Generally, the present system may generate information related to disease susceptibility (risk factors), severity (morbidity) and progression; resource utilization (cost); quality of life (health status and well being); workforce participation and productivity; and mortality. The present system may also integrate a study of the distribution and causes of disease in human populations with cutting-edge genetic and related molecular technologies. The present system may also develop a scale and migratable disease outcomes research and surveillance platform at an interface of genetics and epidemiology that can be applied toward:

Gene Identification—The system may identify genes that may predispose people to cancer (cancer susceptibility genes) whose pathways of action are associated with documented and previously unknown environmental carcinogens and lifestyle exposures.

Risk Quantification—The system may quantify risk resulting from certain types of exposures by studying genetically susceptible subgroups.

Information Integration—The system may integrate information on genetic susceptibility and environmental exposures to estimate cancer risks for individuals, families and populations.

Advance Understanding—The system may contribute to the design of new approaches to prevent, predict, diagnose and treat cancer based on an understanding of how genes modify and interact with environmental exposures.

Generating disease outcomes information that is powerful enough to examine the complex interactions of multiple genetic and environmental factors requires a comprehensive, interdisciplinary research infrastructure that is ideally situated and managed within patient care facilities. A research infrastructure and platform may be developed to generate disease outcomes information from the following activities:

Disease Outcomes and Surveillance Studies—Disease outcomes and surveillance studies may be developed to assess the impact of novel predictive, preventive, diagnostic and therapeutic interventions on disease susceptibility, severity and progression; resource utilization; quality of life; workforce participation and productivity; and mortality.

High-Risk Patient Studies—High-risk patient studies may be developed to evaluate individuals at high risk of cancer as they utilize novel predicative, preventive, diagnostic and therapeutic interventions.

Environmental Exposure Studies—Environmental exposure studies may be developed to assess complex cancer-related environmental exposures.

Family-Based Studies—Family-based studies may be developed to quantify inherited cancer risk and investigate genetic and environmental modifiers of risk and identify potential candidates for novel predictive, preventive, diagnostic and therapeutic interventions.

Population-Based Studies—Population-based studies may be developed to identify clinically valid subpopulations of cancer patients who are unresponsive to conventional therapies and candidates for novel predictive, preventive, diagnostic and therapeutic interventions.

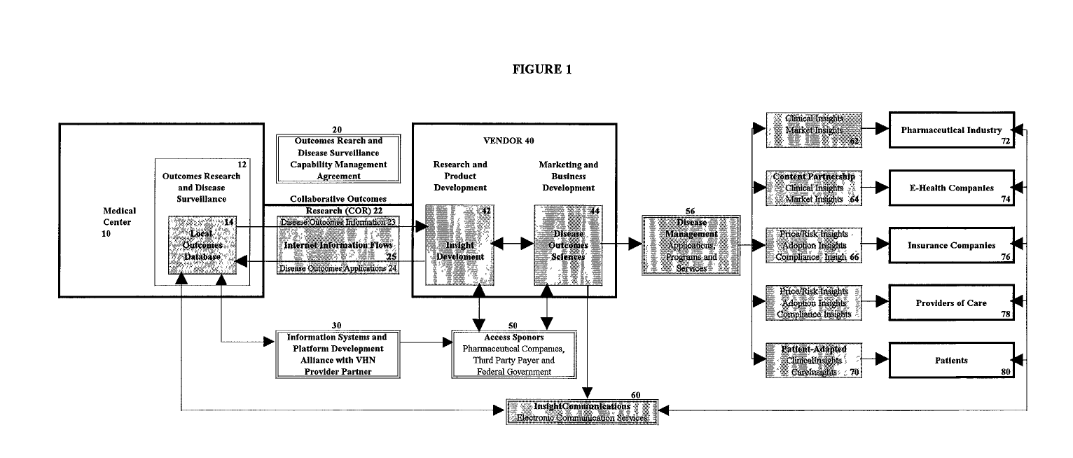

Referring now to FIG. 1, working with one or more hospitals or other academic medical hospitals 10, a data processing vendor 40 may provide computer services to collect, manage, analyze and report clinical, economic and epidemiological data and outcomes information (collectively, “patient data”) collected from diagnosis to death. Hospital 10 may be one or more medical institutions such as an academic medical, secondary or tertiary care hospital, clinic, or any other medical facility that gathers medical or medically-related information on a patient. Vendor 40 may collect patient data from hospital 10 into a local outcomes database 14, and make database 14 available to hospital 10. Patient data may also be collected directly from patients without the intervention of hospitals 10. Patient data may be collected by mail in information forms, telephone surveys, or electronically, via the Internet, electronic mail or other telematic transmission. Alternatively, vendor 40 may install database 14 on site at hospital 10 to be used along side of, or in replacement of, the hospital's pre-existing patient data information legacy systems 210, 213, 217 (discussed below). Vendor 40 may also establish physical operations onsite at hospital 10; for instance, vendor 40 may install a complete computer system including a database, a central processing unit, and multiple terminals at hospital 10, possibly at no cost or with a subsidy to hospital 10, and make that computer system available for the computing needs of hospital 10. Vendor 40 may aggregate together databases 14 from several hospitals 10 to form a network of databases. Alternatively, vendor 40 may create a data warehouse 150 which can be accessible by hospital 10. With appropriate privacy safeguards, hospitals 10 may obtain non-anonymized access to data warehouse 150 to obtain a patient's comprehensive history across all hospitals 10, which may benefit the hospitals' research programs, and may allow improved patient care.

Vendor 40 may also make an anonymized version 1002 of database 14 or data warehouse 150 available to users 72-80 external to hospital 10 (“anonymized data” have had their patient identity encoded or encrypted so that the data cannot be traced to a specific patient, but the data relating to the same specific patient may be identified, and are distinguished from the data of other patients). Vendor 40 may charge a commercial access fee for access by external users 72-80.

Patient data stored in local outcomes database 14 or data warehouse 150 may include information relating to genetic profile, susceptibility, progression, severity of disease, the resources utilized to treat the disease, quality of life, ability to participate in the workforce and survival. Database 14 may also provide hospital 10 with an integrated longitudinal view of individual patients, correlating information from a number of different physicians, hospital departments, disease states, treatments and outcomes, rather than providing views fractured by department or disease state. Such an integrated and correlated local outcomes database 14 may facilitate analysis of a patient's genotype (the genetic makeup of an individual) and phenotype information, along with information relating to the patient's relatives. Such analysis may provide an understanding of why genetically similar patients express the same disease differently. Collecting phenotypic information and linking that information to genotypic information may provide insights into the role that a person's genotype plays in disease contraction, treatment and outcome.

Vendor 40 may provide products, technology, and services provided to academic medical center 10 under an outcomes research and disease surveillance capability management agreement 20. A local outcomes research and disease surveillance information technology may be used to create and populate the local outcomes database 14, in which is collected information on disease susceptibility, severity, progression, resource utilization, quality of life, work force participation and productivity and survival. Local outcomes database 14 may be implemented at the site of the hospital 10.

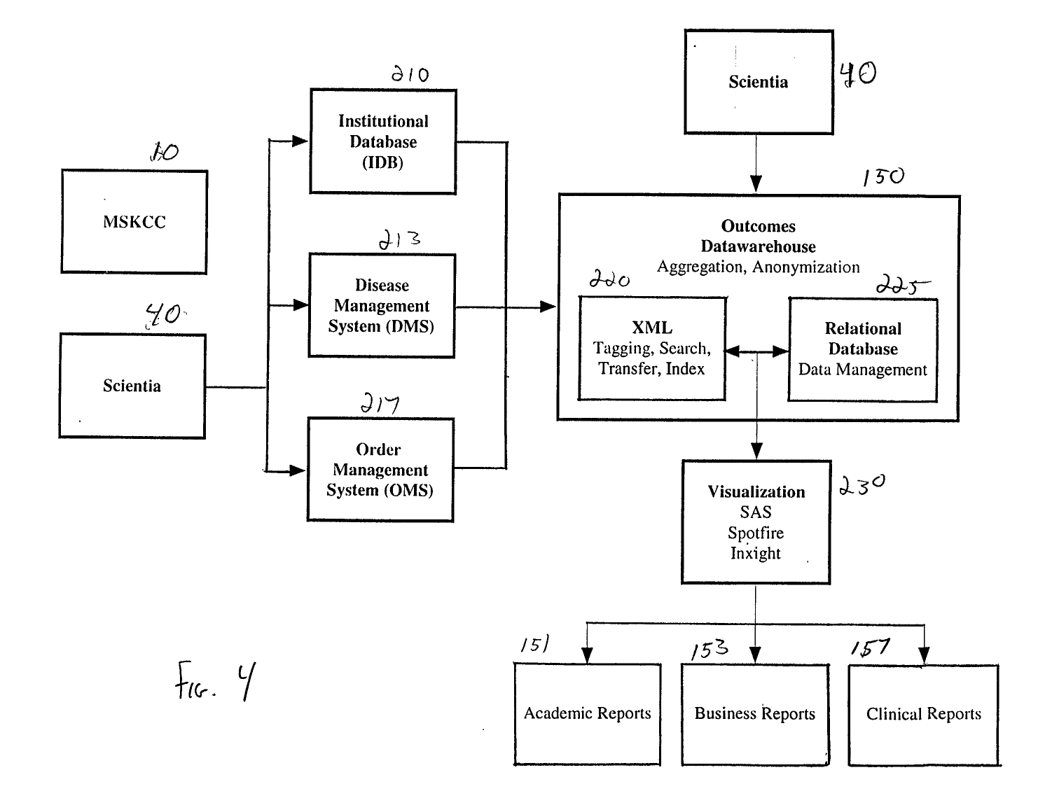

After development of database 14, vendor 40 may create a comprehensive data warehouse 150 (see FIG. 4e) where disease specific outcomes information from other hospitals 10 may also be stored. These other hospitals 10 may independently operate within the system and store, manage and analyze the collected information via an electronic connection such as the internet.

Referring again to FIG. 1, vendor 40 may aggregate and anonymize patient data from affiliated network of hospitals 10 who utilize a networked database system. The patient data may be stored and managed within data warehouse 150 that is a research and product development asset of vendor 40. Vendor 40 may have a marketing and business development aspect where it can mine data warehouse 150 for the purpose of discerning clinical, market, economic, professional practice and other types of insights 62, 64, 66, 68, 70 (hereinafter 62 et seq.). These insights 62 et. seq. may be extracted from data warehouse 150 by an insight extraction application 41 developed in insight developments 42. Insights 62 et. seq. may be of commercial value and offered to potential customers.

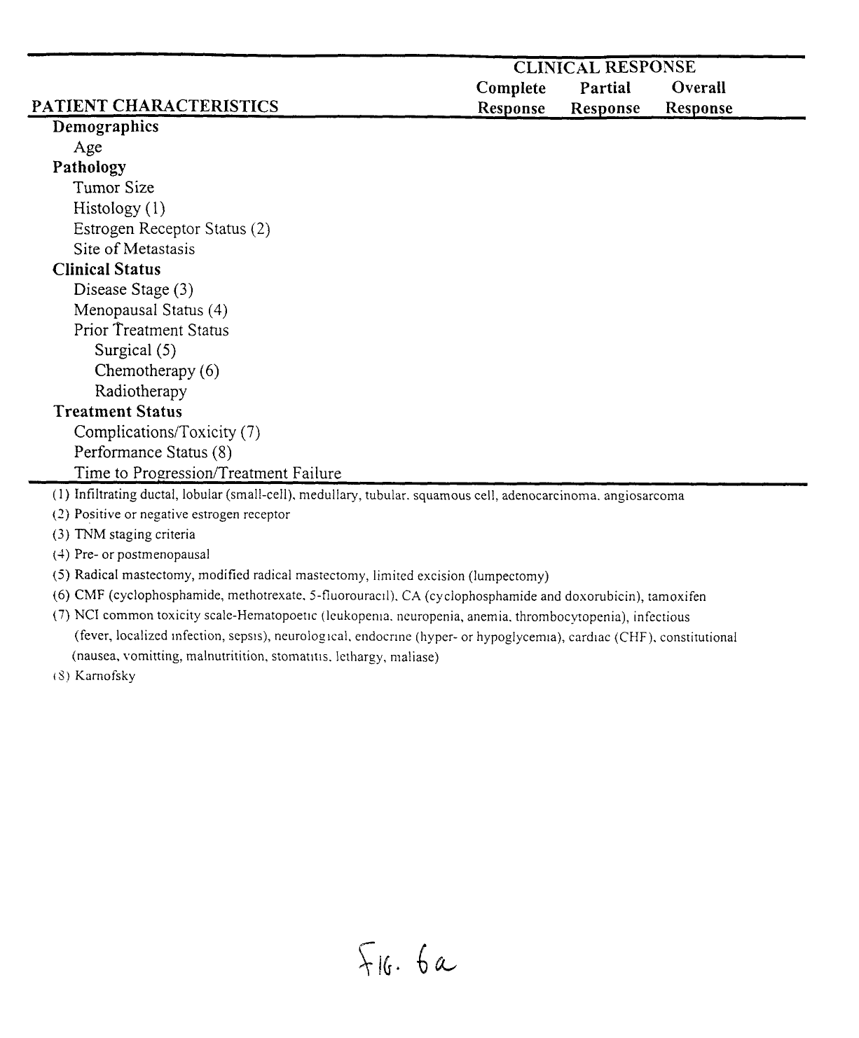

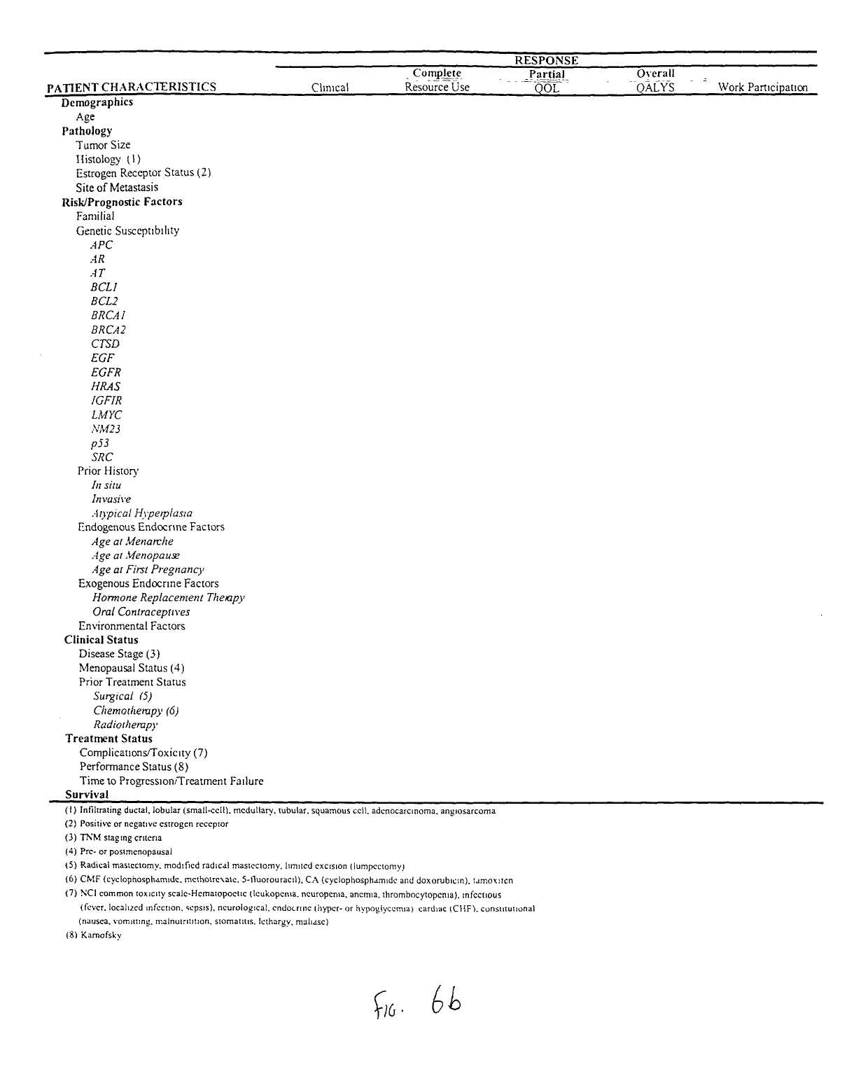

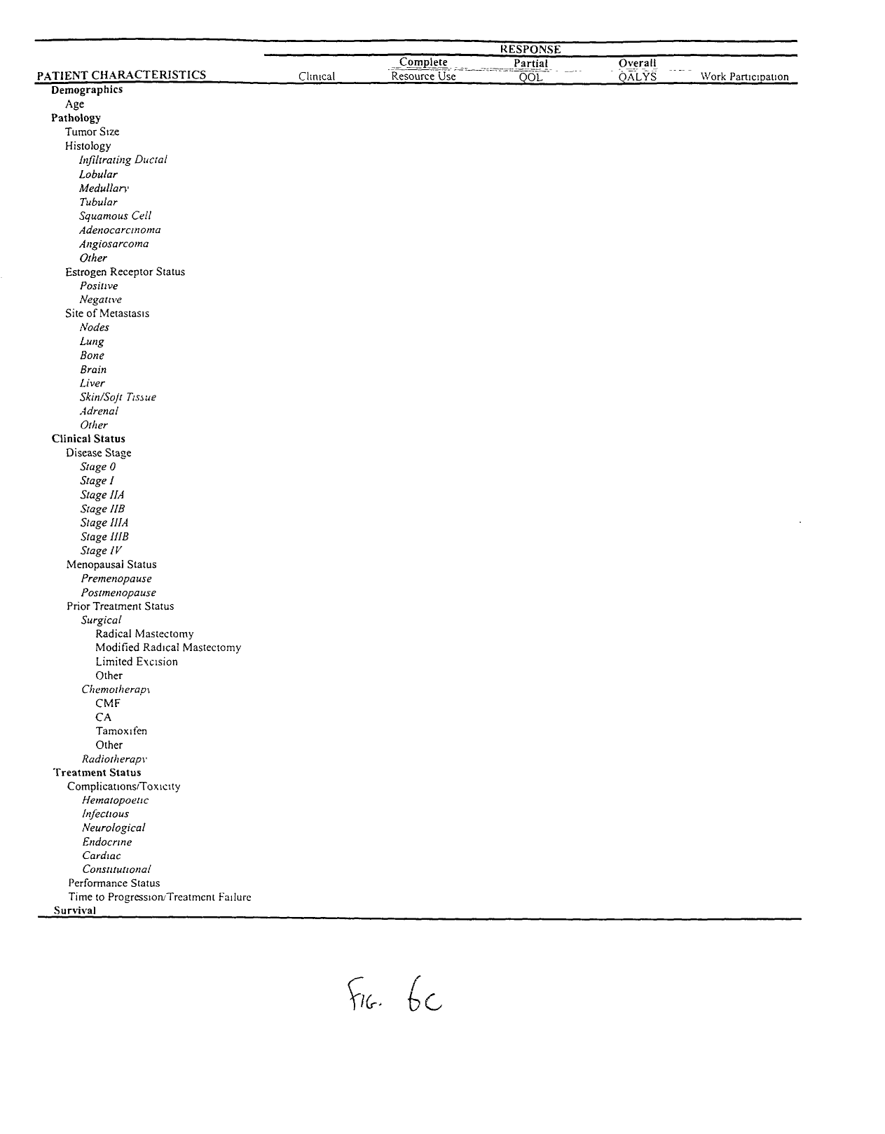

Disease outcomes applications 24 may be developed by vendor 40 and provides to hospital 10 for accessing database 14, data warehouse 150, or insight developments 42. Reports 151, 153, 157 (see FIGS. 4e and 6a-6c) may be issued in response to queries and searches of database 14, data warehouse 150, or insight developments 42 which can be published or accessed by the affiliated network of partners. These reports may be provided to pharmaceutical companies, third party payers, or perhaps governmental entities (box 50), which can apply the information as necessary.

Alternatively, vendor 40 may market and develop research capabilities incident to disease outcomes 44 to pharmaceutical companies, third party payers, or to governmental entities, to provide particular studies of interest either of commercial interest or a public interest.

Examples of possible participating pharmaceutical companies might include Astra-Zeneca, Merck, Bristol-Myers Squibb, Glaxo, Pfizer, and Smith-Kline Beecham. Examples of possible biotech companies might include Amgen, Biogen, and Genentech, and examples of possible genomic companies might include Millennium, Celera, Curagen, Human Genome Sciences and Myriad. Such companies may be potential customers for data warehouse 150 for information and may become affiliated research sites along with hospitals 10 to conduct studies on their particular products.

Vendor 40 may also develop and/or provide disease management applications, programs and services 56. Vendor 40, after processing the gathered longitudinal information into aggregated and anonymized categories, may develop programs and services to take advantage of the insights 62 et. seq. gained from insight developments 42. Vendor 40 may develop products and services for accessing data warehouse 150 that may be commercially valuable to the pharmaceutical industry 72. Such programs may reveal clinical insights (Box 62) into clinical care of a patient 101 and how that care may change due to an intervention made as a result of knowledge gained through analyzing data warehouse 150. Other areas of interest may include market insights (Boxes 62, 64) into where a drug is being used, the quantity, the number of patients in those markets, and where potential markets might exist. Price and risk insights (Boxes 66, 68) provide a better understanding of the value of a certain product for treating a certain, particular patient in a given market, which can help companies price (Boxes 66, 68) their product or help providers 78 enter into risk contracts with payers. Insights 62 et. seq. into how fast physicians adopt these drugs and how patients are using them may be ascertained from the gathered information in data warehouse 150.

Insights 62 et. seq. may be valuable to the pharmaceutical industry 72 and companies now designated as E-health companies 74 (or electronic health companies) that are interested in developing content for websites. Insights 70 may also be desirable to insurance companies 76, who may be interested in understanding how to better manage diseases and how to pay for diseases in a more efficient way. Care providers 78 may use insights 62 et. seq. to provide better care of patients. Patients 80 themselves may look at the gathered information in data warehouse 150 in order to increase their understanding about their own disease.

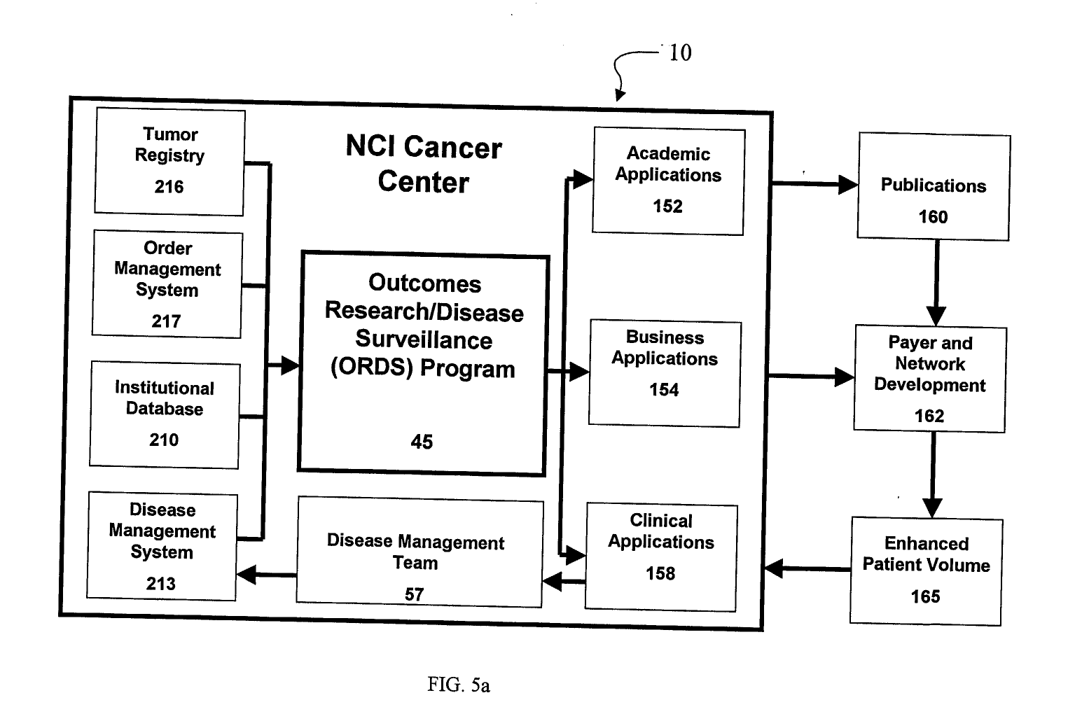

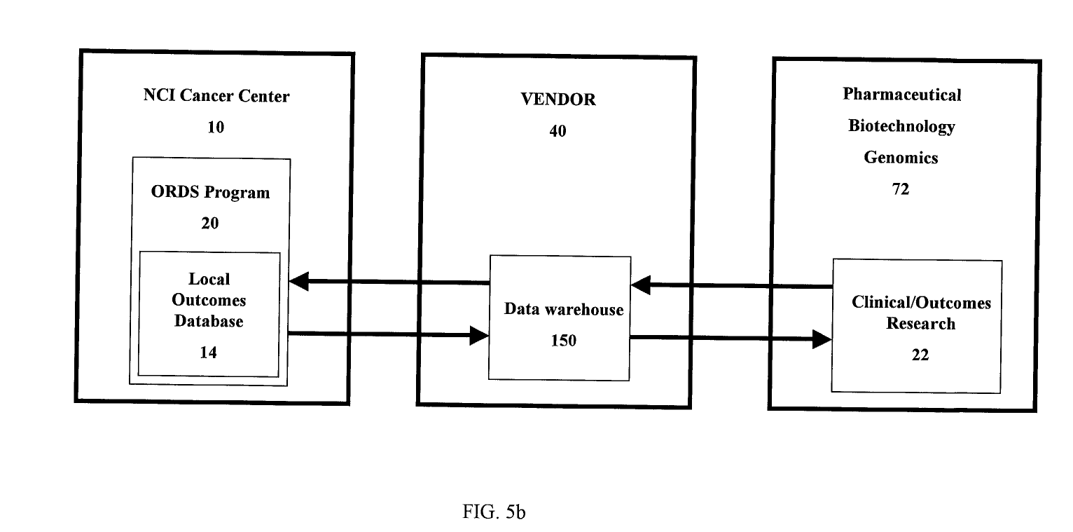

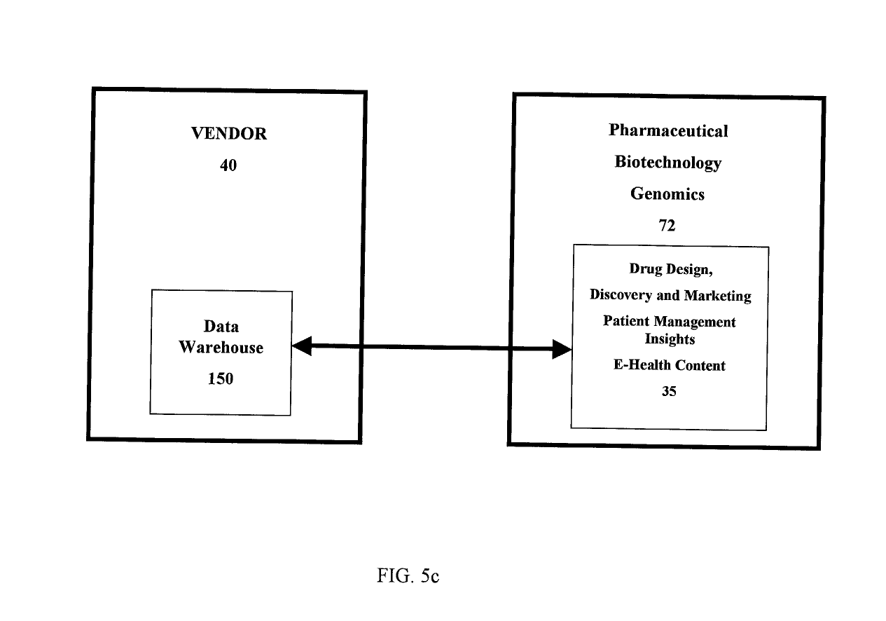

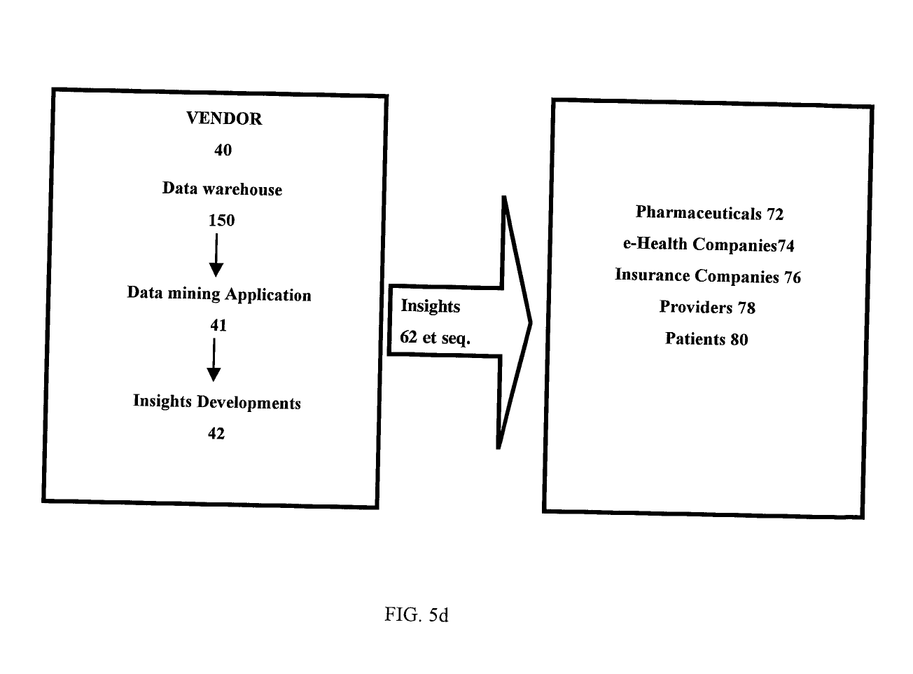

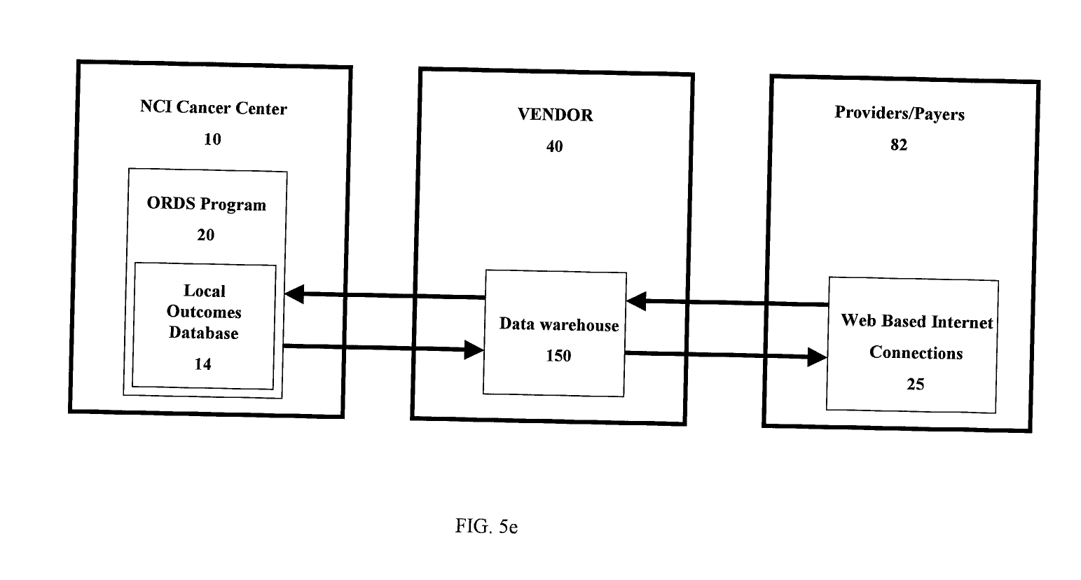

Referring to table 1, another technology developed for the system may include a data mining application 41 which may be used to query data warehouse 150 for the specific insights 62 et. seq. In addition to insight extraction applications that may provide clinical insights and market insights (Boxes 66, 68), there may be reports (see FIG. 5) derived via data mining application 41 queries of data warehouse 150. Other insight 62 et. seq. services may include care insights, risk and price insights, adoption insights, compliance insights and specific custom disease management applications, programs and services used to develop disease-specific patient management guidelines, critical event consultation, premium and case rate pricing and economic risk sharing models, promoting and tracking physician adoption and patient compliance with prescribed interventions.

TABLE 1
Summary of Possible Vendor Products, Technology and Services

| | | Potential Targeted |
|---|---|---|
| Product or Service | Description | Customers |
| Database 14 | Local outcomes database may be used to collect | Provider |
| | information on disease susceptibility, severity, | Pharmaceuticals |
| | progression, resource utilization, quality of life, | |
| | workforce participation and survival. Local | |
| | outcomes database 14 may be implemented at | |
| | academic medical centers. | |
| Data Warehouse 150 | Global comprehensive data warehouse where | Pharmaceuticals |
| | disease-specific outcomes information is may be | Payers |
| | stored, managed and analyzed. Data warehouse | Providers |
| | 150 may be linked via the Internet to Database 14. | E-Health |
| Data Mining Software | Data mining software applications may be used to | Pharmaceuticals |
| Application 41 | query Data Warehouse 150 for specific insights. | Payers |
| | | E-Health |
| Reports 151, 153, 157 | Standing reports derived from queries of Data | Pharmaceuticals |
| Clinical Insights | Warehouse 150 to publish disease-specific | E-Health |
| Market Insights | clinical and market insights. | Payers |
| | | Providers |
| Insight Developments | Custom disease management applications, | Providers |
| 62 et. seq. | programs and services may be used to develop | Payers |
| Care Insights | disease-specific patient management guide- | Pharmaceuticals |
| Risk/Price Insights | lines and critical event consultation; | |
| Adoption Insights | premium and case rate pricing and economic | |
| Compliance Insights | risk-sharing models; and promoting and | |
| | tracking physician adoption and patient | |
| | compliance with prescribed interventions. | |
| Electronic | Internet electronic communication services may | Pharmaceuticals |
| Communications | be used to disseminate reports, programs and | E-Health |
| Services 60 | services to customers and patients. | Patients |
| Insight | | |
| Communications | | |
| DiseaseOutcomes.com | | |

Insights 62 et. seq. developed from mining data warehouse 150, may be communicated either to the customer segment directly or to a network of care providers affiliated with vendor 40. The network of affiliated care providers may gather these insights 62 et. seq. and act upon them in a timely fashion so that new insights that can have impact on patient care. Additionally, knowledge gained from insights 62 et. seq. can be incorporated in the treatment regimes at a much faster pace than they would through dissemination of information at medical meetings or in journals where the lag time for publishing results is much longer.

Electronic communication services 60 may be implemented to provide internet based access 25 to data warehouse 150 through an insight communications website portal. One embodiment may observed at the url: www.diseaseoutcomes.com. The website portal may provide internet electronic communication services 60 to disseminate reports 151, 153, 157, programs and services 56 to vendors 40, hospitals 10, customers 72, 74, 76, and patients 101.

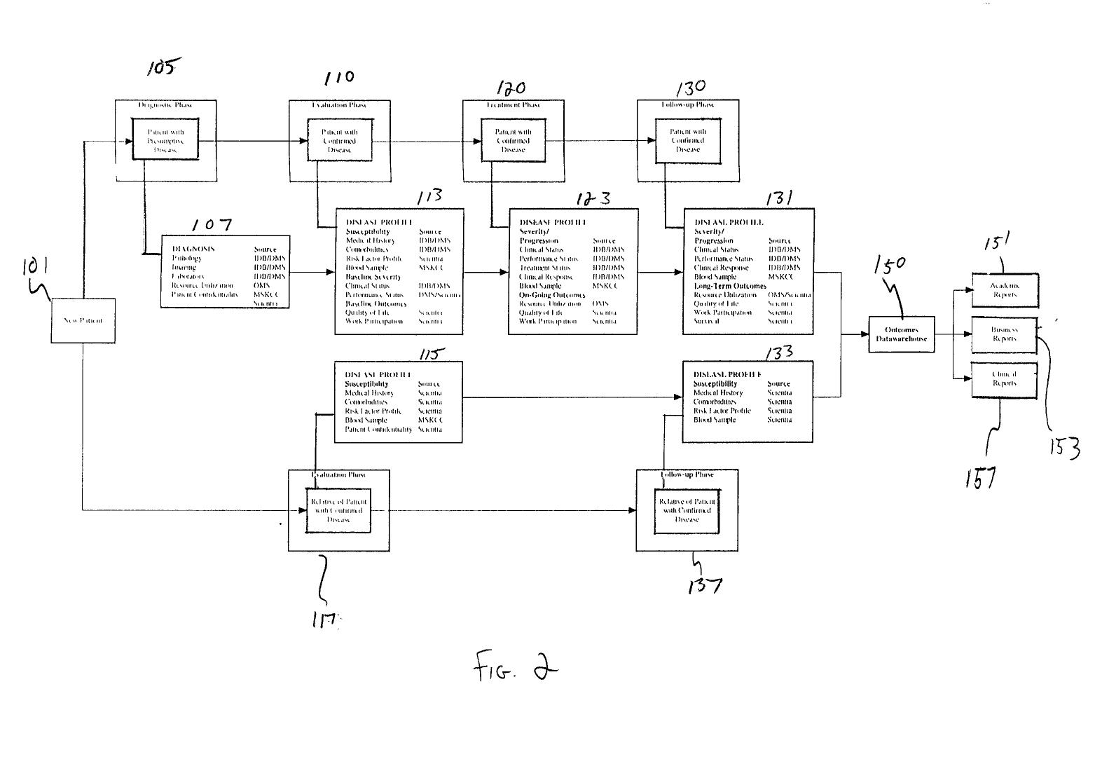

Referring now to FIG. 2, a new patient 101 (for example, having a suspected breast cancer) enters a diagnostic phase 105 where tests are conducted 107 (see FIG. 4a). To confirm a diagnosis, the information is collected, for example, on pathology of a tumor after it has been biopsied. Imaging studies may also be conducted to localize the tumor, and lab studies may be conducted to further define the extent of the disease. In the course of the diagnostic phase many resources may be utilized including those of academic hospitals accessed via the local outcomes database 14. Vendor 40 may have access to many databases including those of hospital 10 where patient 101 is physically located, i.e., where patient 101 is being managed. For instance, an institutional database 210 (IDB) located at hospital 10 may include information on medical history, physical examination results, laboratory results, imaging results, drugs that have been prescribed, disease staging, tumor staging, and clinical status. Vendor 40 may have access to IDB 210 of hospital where patient 101 is located for real time access to the elements of information on pathology, imaging, lab and resource utilization stored within local databases. Alternatively, insight database 62 et. seq. may be integrated with IDB 210.

Once a patient 101 has been diagnosed with a disease, patient 101 may be provided with information regarding the system and how it works. Patient 101 may be given the choice to opt out of the system or to allow free access to the information related to their disease and how it affects him or her personally. Patient 101 may be advised of his/her privacy lights and that all the information gathered will be anonymized when added to the system or provided outside hospital 10. With the permission of patient 101, and after a confidentiality agreement is executed by patient 101, the patient's information is added local outcomes database 14.

When patient 101 has been diagnosed he or she enters an evaluation phase 110. During the evaluation phase 110 one or both of two disease profiles may be developed: a first disease profile 113 for the diagnosed patient 101; and a second disease profile 115 for a relative of the patient with the confirmed disease 117. Each disease profile 113, 115 includes information relating to medical history, comorbidities, which are other diseases that a patient has that are either related or unrelated to their primary disease, a risk factor profile and blood samples. For a patient with cancer, typical information gathered on comorbidities may include information on types of conditions that are affecting the patient such as hypertension.

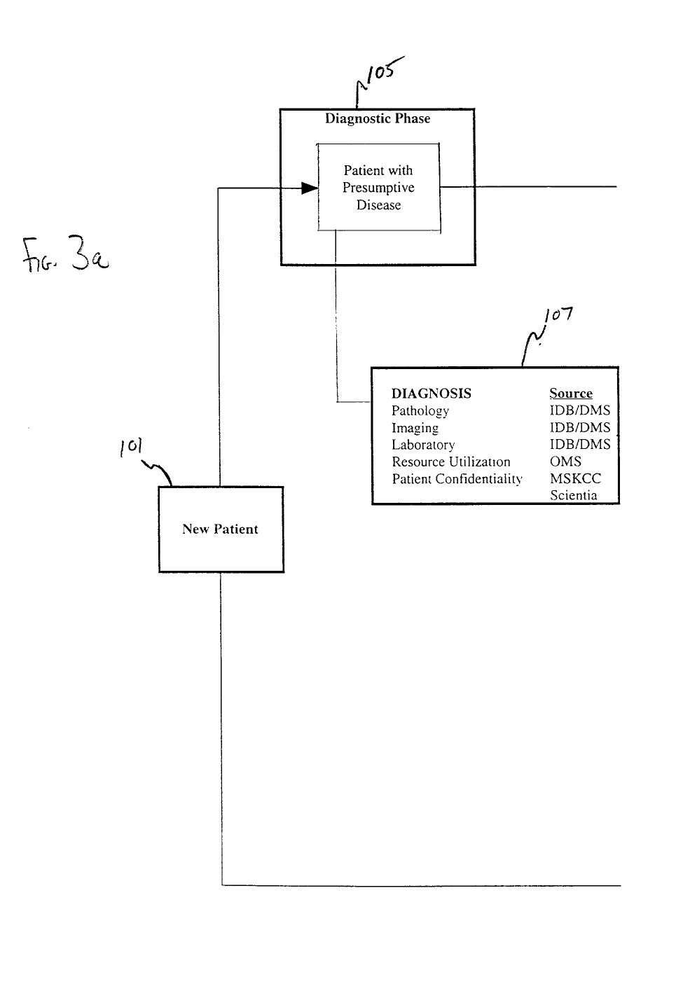

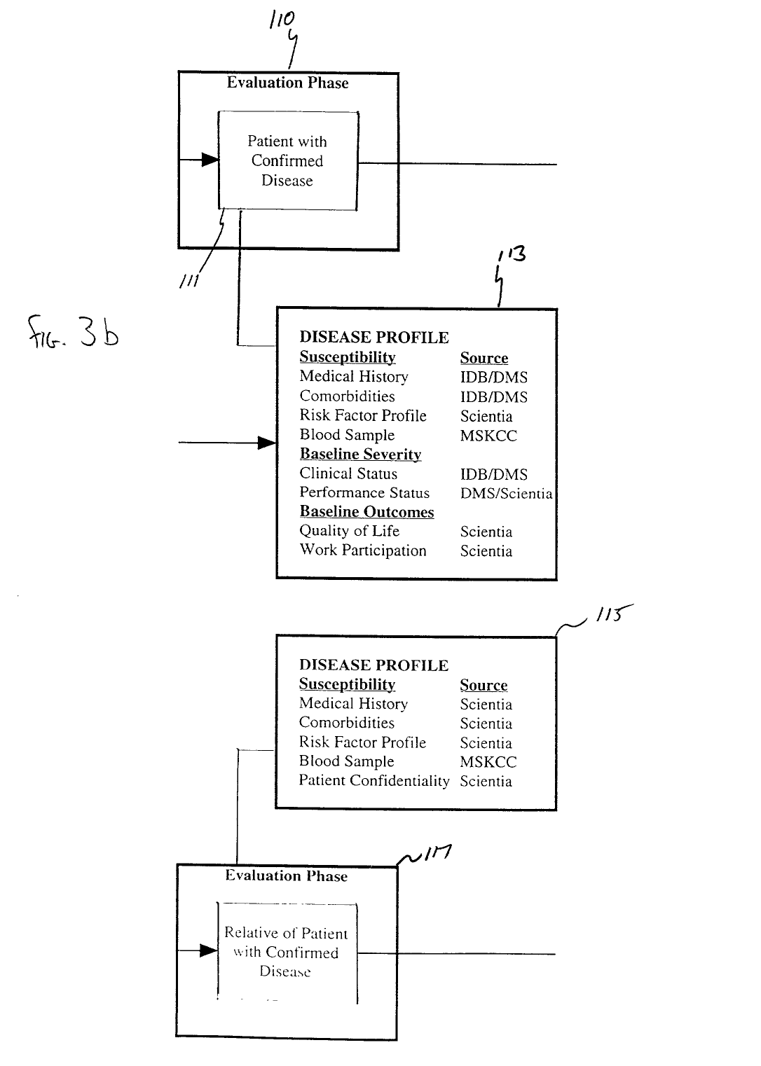

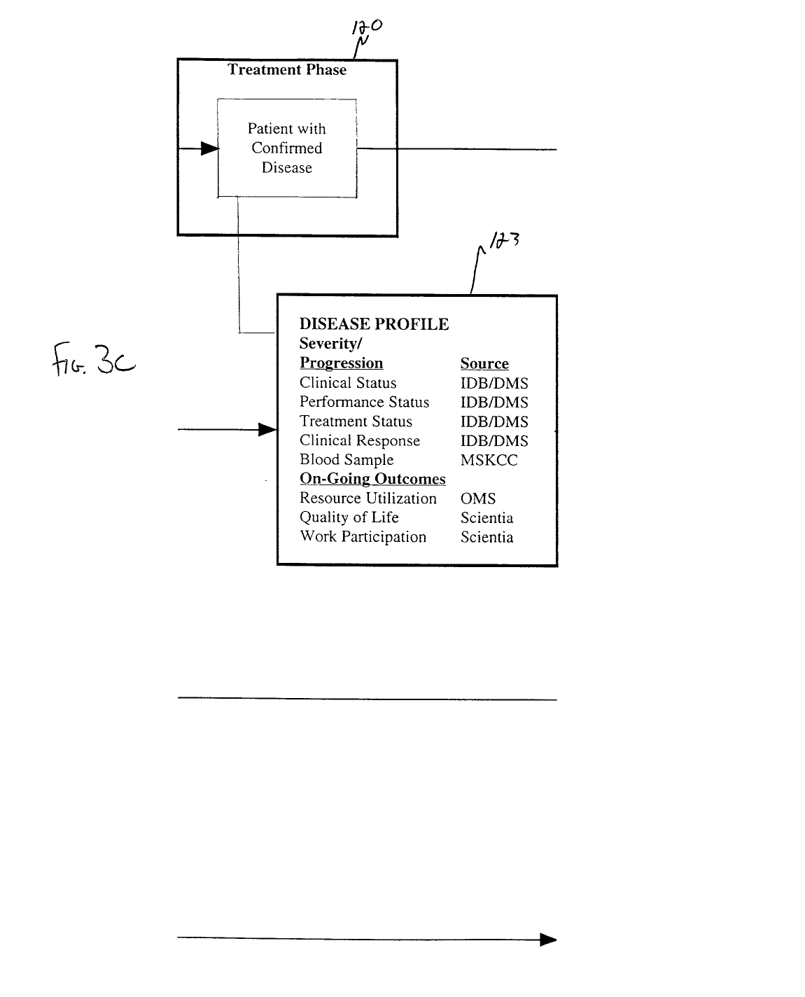

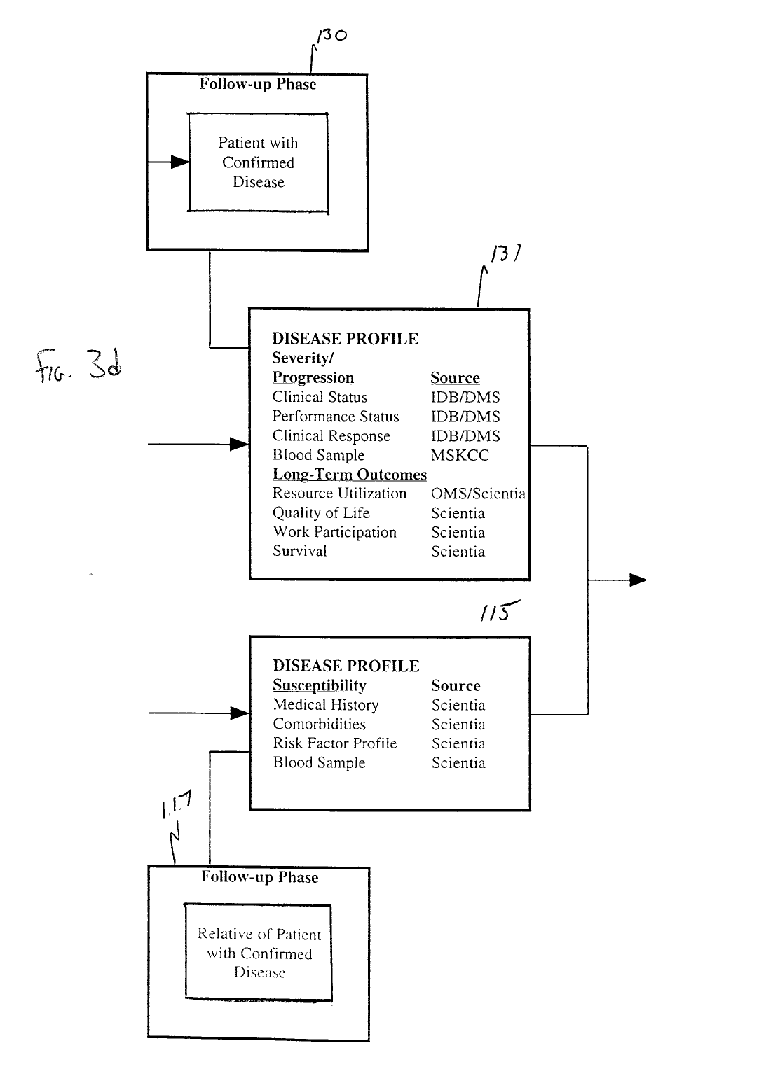

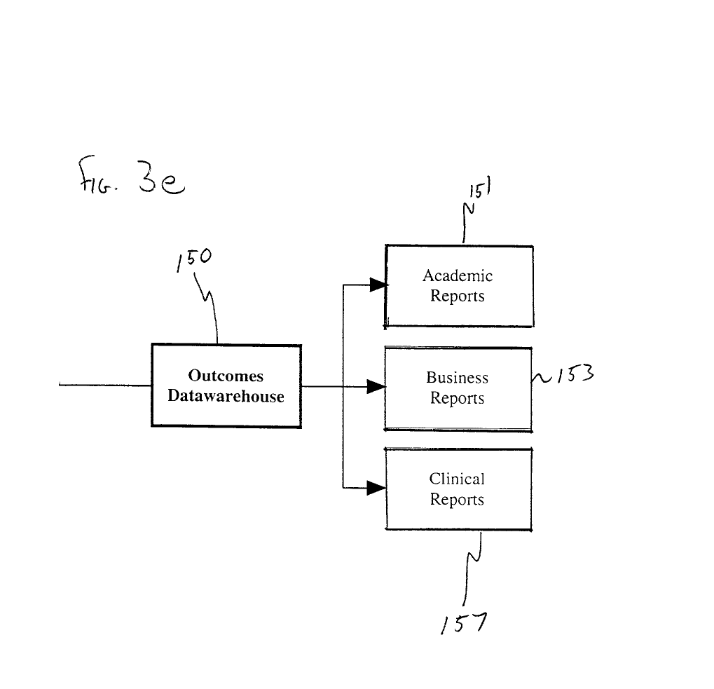

Disease profile 113 may be developed during the period of time between diagnosis and treatment. Disease profile 113 may include a baseline profile that includes a computer database record and a biological sample record regarding patient 101. The baseline profile can also include information on disease susceptibility, which can be derived from medical history. The source of the medical history and the co-morbidity information may be the IDB 210 or the local disease management system 213 (DMS) (see FIG. 3b). A risk factor profile may also be developed that may include information on the social history of patient 101. For example whether patient 101 smokes cigarettes, uses alcohol or drugs, or has other social habits that may have contributed to the disease. The risk factor profile may also take into account a patient's environmental exposures, including the patient's work history, possible exposure to toxins or to carcinogens such as asbestos. Exposure to known carcinogens and other toxic substances may be inventoried at this time and assessed as a risk factor. The baseline profile may also include a blood sample information which is collected, catalogued, stored and may be made available for further genetic analysis, if necessary, to come to a further or better understanding of the genetic makeup of the patient and how that genetic makeup may have been mutated by environmental factors that resulted in the disease.

Disease profile 113 of patient 101 may contain additional information known as baseline severity. Baseline severity may include clinical status information and performance status information. Clinical status information may include information such as disease stage, menopausal status and prior treatment status. One possible measurement of performance status is the well known Karnofsky performance status assessment, which is a validated instrument used to evaluate a patient's ability to practice activities of daily living while they have the disease. The Karnofsky assessment uses a scale graded between 0% to 100%, where 100% represents a patient having a disease but no deficiencies from such disease, and 0% represents the patient being dead. The rate of disability increases as the score decreases. The baseline outcomes generated may be applied to prospective surveys on quality of life and workforce participation in disease profile 113 (see FIG. 3b).

Referring to FIG. 3b, a disease profile 115 may be created for each of one or more blood relatives of patient 101. As conducted with the patient 101, longitudinal medical information may be collected from the relatives of patient 101. Such information collected may include medical histories, co-morbidities, risk factor profiles, and a blood sample for further genetic analysis. Similar to patient 101, the relative of the patient may be advised of the privacy rights at issue and a confidentiality agreement may be entered.

Referring to FIG. 3c, upon completion of evaluation phase 110, patient 101 enters the treatment phase 120. During treatment phase 120, patient 101 may receive a number of different drugs that may be cycled over a period of thirty days. Disease profiles 113, 115 may be updated any number of times during treatment phase 120 until patient 101 is either in remission or the disease has progressed to the point where patient 101 is no longer eligible for treatment. The information collected during treatment phase 120 may include information on the severity of progression, clinical status and performance status as previously defined. The source of that information can be the IDB 210 or its DMS 213. Local outcomes database 14 and data warehouse 150 (see FIG. 3c) may be compiled 127 with the information from disease profiles 113, 115 including susceptibility, severity, progression, and with on-going outcomes information such as resource use, quality of life, and work force participation.

Clinical status information in disease profiles 113, 115 may include complications of toxicity as it relates to treatment status. NCI applies a common toxicity scale for certain complications that fall into hematological complications, which are complications of the blood that may be related to low blood cell counts. These hematological complications may include low white cell counts (leukopenia), paucity of neutrophils (neutropenia), low red blood cell counts (anemia), or low platelet counts (thrombocytopenia). There are infectious complications, which include fever, localized infection or sepsis, which is an infection within the blood that's due to doses of chemotherapy that cause low white blood cell counts, hence limiting the ability of patient 101 to fight infection. Alternatively, there may be neurological, endocrine, cardiac or other types of constitutional complications that fall under the treatment status, which may be collected at this time.

There may also be information collected on clinical response (see FIG. 6a). Categories of clinical response may include complete response, partial response or no response. A complete response includes the case where there is an absence of disease after treatment. A partial response includes, for example, that the size of the tumor has decreased in size during treatment but has not been completely eliminated. Information can also be collected from patients 101 that did not respond at all, which indicates that the tumor did not shrink in size or it increased in size during the treatment process. Overall response is the average of complete and partial responses.

Referring to FIG. 3d, following the end of the treatment phase 120 patient 101 may enter a follow-up phase 130. Follow up phase 130 may include an aftercare period, a period after which patient 101 may be in remission, until patient 101 experiences a relapse, or until patient 101 no longer requires monitoring. During follow-up phase 130, disease profile 131 for patient 101 may be amended to include information regarding long-term outcomes data. Blood samples may also be collected at various points during this period of time. Additional risk factors may also be determined for example, during the remission phase, if there is any exposure to substances that might be cause a relapse or cause exposure to another tumor. Long-term outcomes are may be collected again such as resource issues, quality of life, workforce participation and, ultimately, survival. This information may be added to databases 14, 150 as collected.

Vendor 40 may continue to monitor both patient 101 with a confirmed disease and his or her relatives. Additionally, during this period disease profiles 113, 115 for both patient 101 and his or her relatives may be updated to track patient's 101 and his or her relatives' respective clinical status, performance status, and clinical response. For the relatives of patient 101, additional information may be collected such as medical history, co-morbidities, risk factors, and blood samples. Each of the relatives of patient 101 may be monitored for an extended period of time, usually on a regular basis, perhaps once or twice a year until patient 101 dies or develops acute disease and falls into a different category.

Referring to FIG. 3e, data warehouse 150 can be a single location where all gathered information is stored and aggregated. Reports can be created using the information from data warehouse 150 including academic reports 151, business reports 153, and clinical reports 157.

The phenotypic information stored in data warehouse 150 may assist in expressing a patient's 101 genetic makeup in a negative manner that may be indicative of contributory factors relating to patient's 101 contraction of the disease. In addition, the phenotypic information can be matched to a blood sample that contains genetic data about patient 101 and his or her relatives. This matching of phenotypic and genetic information may create a phenotypic expression indicative of a particular disease that may be become an asset of both vendor 40 and hospital 10.

Referring to FIG. 4, information may be gathered by routine collection of data by the doctors and nurses from a patient input onto standard patient data forms (discussed below and see FIGS. 6a-6c). Through an electronic interchange the patient data may be stored in any one or a combination of legacy systems 210, 213, 217 within hospital 10, which may be, for example, Memorial Sloan Kettering Cancer Center. Legacy systems 210, 213, 217 of hospital 10 may include institutional database (IDB) 210, disease management system (DMS) 213, and an order management system (OMS) 217, where OMS 217 tracks the resources that are used to care for patients 101. IDB 210 that may store clinical information and DMS 213 may store clinical information under various defined protocols incident to patient 101 given his or her disease and the stage thereof.

Both vendor 40 and hospital 10 may contribute newly collected information to legacy systems 210, 213, 217. Items of information for which vendor 40 needs to develop programs may be designated from the legacy systems 210, 213, 217. Vendor 40 may also collect information that may not necessarily be derived from legacy systems 210, 213, 217 in order to supplement the legacy systems 210, 213, 217 information resource. Information flows and technology developed by vendor 40 may be directly integrated into legacy systems 210, 213, 217 of hospital 10. Alternatively, vendor 40 and hospital 10 may use local outcomes database 14 to store patient data that may be integrated directly with legacy systems 210, 213, 217 and data warehouse 150.

Vendor 40 may also supplement data warehouse 150 by implementing an evolving technology known as XML, (Extensible Markup Language) 220 to tag, search, transfer and index the gathered information to a common language. Legacy systems 210, 213, 217 of hospital 10 may be built on one or a variety of common software database systems such as Oracle, Cybase, or DB2. By using XML technology to tag the information within legacy systems 210, 213, 217, vendor 40 may aggregate information from disparate data sources into a common format. From that common format, the data may be translated into and communicated into whichever language is chosen as the format for data reporting.

From the common format, vendor 40 may use a relational database 225 to manage, analyze, and visualize 230 the information via various commonplace software tools and newly created applications. Once the information is visualized 230 it can be reported in the form of academic reports 151 such as publications and research documents that can be presented at conferences and the like. Alternatively, the information can be presented in business reports 153 used to facilitate payer and network development negotiations. Clinical reports 157 may also be used to provide the information, which may continually improve the clinical care being provided at the hospital.

Academic report 151 can be used to describe, for example, the characteristics of patient 101 who is treated with a particular drug and the clinical response is being evaluated. For example, characteristic information collected from patient 101 would be demographic information such as age, pathologic information related to their tumor size, or the histology of the tumor. For example, in the case of breast cancer, the histology would be designated as infiltrating ductal, lobular, modular, tubular or other designations of the site of metastases.

Reports 157 may include information such as the stage of the disease, any prior surgical and non-surgical treatment, chemotherapy or radiation therapy. Reports 157 may include treatment status, which may describe a level of complications or toxicity, and the performance status. Still another outcome that may be tracked is the time to progression or when the treatment actually failed. All of the information may be considered and compared as it relates to complete response, partial response or overall response.

Referring to FIGS. 5a-5e, hospital 10 can be, for example, an NCI cancer center that may have an Outcomes Research/Disease Surveillance (ORDS) Program 45 established. In addition to legacy systems 210, 213, and 217, hospital 10 may include a tumor registry 216 where information related to various types of tumors may be stored. Using ORDS program 45 hospital 10 may develop academic applications 152, business applications 154, and clinical applications 158. Academic applications 152 can include various publications 160 and business applications 154 can facilitate Payer and Network Development 162, which in combination can provide Enhanced Patient Volume 165.

Referring to FIG. 5b vendor 40 may be integrated with hospital 10 and customer segments 72 via direct linking of data warehouse 150, local outcomes data warehouse 14, and clinical outcomes research 22. Customer segments 72 may include pharmaceutical, biotechnology, genomics or other third party business. Customer segments 72 may also include applications 35 such as drug design, discovery and marketing divisions, patient management insights, and e-health content (FIG. 5c). In one embodiment vendor 40 may use data mining application 41 to mine data warehouse 150 and apply the information gained therefrom to insights developments 42. Insights 62 et seq. may be directly provided to the customer segments including pharmaceuticals 72, e-health companies 74, insurance companies 76, care providers 76, and patients 101 (FIG. 5d). Care providers/payers may access data warehouse 150 via web based Internet connections 25.

Referring now to FIGS. 6a-6c, hospital 10 may be able to define a particular response level. Similar characteristics may be used to define a response level of patient 101, whether it be complete or partial, which can be represented in five elements about clinical outcomes. Vendor 40 may collect and report information regarding clinical outcomes, resource utilization, quality of life, workforce participation, and ultimately, survival. Vendor 40 may also add information to comparisons of response rates known as Quality Adjusted Life Years Saved or QUALYS. QUALYS is a calculation which uses quality of life and resource utilization to determine a measure of the value of a certain procedure or treatment in economic terms. QUALYS allows hospital 10 and patient 101 to determine the cost of healthcare, the likelihood and timing of survival, and the incident quality of life.

Workforce participation may be determined by surveying the patient's occupation, the salary level, time lost from work and the economic loss related to both loss of earnings or paying taxes as calculated. Also determined may be the length of time it takes for a patient to get back to work and the level of productivity they are working at in conjunction with disease management.

Referring to FIG. 6c, a clinical report 151 may incorporate risk and prognostic factors or the susceptibility to the disease as another way of evaluating a patient's response. For example, in the risk prognostic factors category, it is possible to define genetic susceptibility, which could be any number of genes associated with the cancer that the user is evaluating. Clinical report 151 may also include a factor a prior history of exposure, including environmental exposures that may have mutated these genes or may have been responsible for the actual creation of the cancer.

Sequencing genetic information may also be ascertained by providing access to the information collected from patient 101 and the relatives of patient 101. Certain genes responsible for certain tumors can be located and the resulting tumors may be more responsive based on the genetic makeup to certain treatments than they would be responsive to other ones. For example, some of those genetic genes may relate to severity which translates to, gene A is responsible for tumor A and tumor A is responsive to treatment A. In this case, treatment B, C or D would not, be used because treatment A is known to work best. On the other hand, gene B, which is responsible for tumor B, may be present and may not have a responsive treatment B for it. Treatment A, C or D or a combination of those may be used in this case to get control of the tumor. However, if the disease is not responsive to any of those treatments the disease, itself, would be more severe and progress more rapidly.

As a result, tailor made treatments can be provided to certain tumors that have a genetic basis, and a clinical report 151 form can be generated (see FIG. 6c) which can include the actual genetic susceptibility for which patient 101 may be at risk. Incident to that risk, a determination can be made relating to some patients with a particular gene in that whether when treated with treatment A patient 101 has more complete responses than when treated with treatment B. This determination may result in an increased knowledge base regarding how to effectuate complete responses when certain genes are present and because of the particular gene present the resulting tumor is more responsive to treatment A. Therefore, in this scenario, treatments B, C or D will not be used anymore.

Although the present invention has been described in detail with respect to certain embodiments and examples, variations and modifications exist which are within the scope of present invention as defined in the following claims

What is claimed is:

1. A method for processing medical information comprising the steps of:
gathering longitudinal medical information of a patient; and
aggregating and anonymizing the longitudinal medical information into selected categories incident to a particular disease.

2. The method for processing medical information according to claim 1, further comprising the step of gathering longitudinal medical information from a relative of the patient.

3. The method for processing medical information according to claim 2, further comprising the step of generating information in the group consisting of disease susceptibility, severity, and progression.

4. The method for processing medical information according to claim 3, further comprising the step of generating information in the group consisting of quality of life, workforce participation, productivity and morbidity.

5. The method for processing medical information according to claim 4, further comprising the step of identifying genes that may predispose people to cancer whose pathways of action are associated with documented and previously unknown environmental carcinogens and lifestyle exposures.

6. The method for processing medical information according to claim 5, further comprising the step of quantifying risk resulting from environmental carcinogens and lifestyle exposures.

7. The method for processing medical information according to claim 6, further comprising the step of integrating information on disease susceptibility and environmental carcinogens and lifestyle exposures in order to estimate cancer risks for individuals, families and populations.

8. A method for processing medical information of a patient comprising the steps of:
gathering medical information of at least one patient in order to determine phenotype information; and
communicating the medical information in an aggregated and anonymized format to at least one hospital.

9. The method for processing medical information according to claim 8, further comprising the step of gathering medical information from at least one relative of the patient.

10. The method for processing medical information according to claim 9, further comprising the step of generating information in the group consisting of disease susceptibility, severity, and progression.

11. The method for processing medical information according to claim 10, further comprising the step of generating information in the group consisting of quality of life, workforce participation, productivity and morbidity.

12. The method for processing medical information according to claim 11, further comprising the step of identifying genes that may predispose people to cancer whose pathways of action are associated with documented and previously unknown environmental carcinogens and lifestyle exposures.

13. The method for processing medical information according to claim 12, further comprising the step of quantifying risk resulting from environmental carcinogens and lifestyle exposures.

14. The method for processing medical information according to claim 13, further comprising the step of integrating information on disease susceptibility and environmental carcinogens and lifestyle exposures in order to estimate cancer risks for individuals, families and populations.

15. A method for correlating longitudinal medical information of a patient afflicted with disease comprising the steps of:
gathering longitudinal medical information of the patient afflicted with disease and from relatives of the patient from at least one hospital where such longitudinal medical information is collected;
determining phenotype information from the gathered longitudinal medical information; and
communicating the longitudinal medical information aggregated and anonymized to at least one hospital.

16. The method for correlating medical information according to claim 15, further comprising the step of generating information in the group consisting of disease susceptibility, severity, and progression.

17. The method for correlating medical information according to claim 16, further comprising the step of generating information in the group consisting of quality of life, workforce participation, productivity and morbidity.

18. The method for correlating medical information according to claim 17, further comprising the step of identifying genes that may predispose people to cancer whose pathways of action are associated with documented and previously unknown environmental carcinogens and lifestyle exposures.

19. The method for correlating medical information according to claim 18, further comprising the step of quantifying risk resulting from environmental carcinogens and lifestyle exposures.

20. The method for correlating medical information according to claim 19, further comprising the step of integrating information on disease susceptibility and environmental carcinogens and lifestyle exposures in order to estimate cancer risks for individuals, families and populations.

21. A method for correlating longitudinal medical information of at least one patient afflicted with disease comprising the steps of:
gathering longitudinal medical information from each one of at least one patient afflicted with disease and from a relative of each one of the at least one patient from at least one hospital where such longitudinal medical information is collected to determine phenotype information;
anonymizing the longitudinal information;
storing the longitudinal information on a database accessible to at least one hospital; and
communicating the longitudinal information aggregated and anonymized to at least one hospital.

22. A method for processing longitudinal medical information of at least one patient afflicted with disease comprising the steps of:
collecting the longitudinal medical information from each patient as each one of the at least one patient progresses through a diagnostic, a treatment and a follow-up stage of the disease;
anonymizing the longitudinal medical information; and
storing the longitudinal information on a database accessible by at third party user.

23. A method for processing longitudinal medical information of at least one patient afflicted with disease comprising the steps of:
gathering longitudinal medical information from at least one hospital where such longitudinal medical information is collected and managed;
aggregating the longitudinal medical information;
anonymizing the longitudinal information;
determining phenotypic information from the longitudinal medical information; and
storing both the longitudinal information and the phenotypic information in at least one database accessible by a third party user.

24. A method comprising the steps of:
gathering longitudinal medical information from at least one patient afflicted with disease and from relatives of each one of the at least one patient from at least one hospital where such longitudinal medical information is collected; and
communicating the longitudinal information in an aggregated and anonymized format to at least one hospital.

25. A method for determining phenotype information comprising the steps of:
gathering longitudinal medical information of at least one patient from at least one hospital where such longitudinal medical information is collected;
aggregating the longitudinal medical information;
anonymizing the longitudinal medical information;
comparing the longitudinal medical information gathered from each one of the at least one patient with predetermined genetic data ascertained from both each one of the at least one patient and at least one relative of each one of the at least one patient;
determining a phenotypic expression of the comparison; and
storing the longitudinal medical information and the phenotypic expression in a database accessible by a third party user.

26. The method for determining phenotype information according to claim 25, further comprising the step of gathering medical information from at least one relative of the patient.

27. The method for determining phenotype information according to claim 26, further comprising the step of generating information in the group consisting of disease susceptibility, severity, and progression.

28. The method for determining phenotype information according to claim 27, further comprising the step of generating information in the group consisting of quality of life, workforce participation, productivity and morbidity.

29. The method for determining phenotype information according to claim 28, further comprising the step of identifying genes that may predispose people to cancer whose pathways of action are associated with documented and previously unknown environmental carcinogens and lifestyle exposures.

30. The method for determining phenotype information according to claim 29, further comprising the step of quantifying risk resulting from environmental carcinogens and lifestyle exposures.

31. The method for determining phenotype information according to claim 30, further comprising the step of integrating information on disease susceptibility and environmental carcinogens and lifestyle exposures in order to estimate cancer risks for individuals, families and populations.

32. A method for determining a correlation between genetic predispositions and phenotype information in order to successfully treat disease, the method comprising the steps of:
correlating longitudinal medical information gathered from at least one hospital where such longitudinal medical information is collected where the longitudinal information being collected from at least one patient having a disease and at least one relative of each one of the at least one patient;
aggregating the longitudinal medical information;
anonymizing the longitudinal medical information; and
storing the longitudinal information in a database accessible by at least one user.

33. The method for correlating longitudinal medical information according to claim 32, further comprising the step of communicating the longitudinal medical information to at least one hospital.

34. A method for correlating longitudinal medical information of a patient comprising the steps of:
gathering longitudinal medical information to determine phenotype information from at least one hospital where such longitudinal medical information is managed;
aggregating the longitudinal medical information;
anonymizing the longitudinal medical information; and
storing the longitudinal information in a database accessible by at least one hospital.

35. A method for doing business, the method comprising the steps of:
providing computer hardware to a medical institution at less than market price, in return for access to patient data generated at the medical institution.

36. The method according to claim 35, further comprising the step of selling the patient data available in an anonymized form to customers outside the medical institution.

37. A method comprising the steps of:
aggregating patient data drawn from multiple incompatible databases into a single database in an anonymized form, and providing access to the single database to a user.

38. A system for managing clinical information comprising:
a first database for storing patient data;
a computer interconnected to the first database, the computer programmed to anonymize and aggregate the patient data; and
a second database, interconnected to the computer, the second database for storing the anonymized and aggregated the patient data

39. The system according to claim 38, wherein the first database includes information in the group consisting of genetic profile, disease susceptibility, severity, and progression.

40. The system according to claim 39, wherein the second database includes information in the group consisting of quality of life, workforce participation, productivity and morbidity.

41. The system according to claim 40, wherein the computer is programmed to identifying genes that may predispose people to cancer whose pathways of action are associated with documented and previously unknown environmental carcinogens and lifestyle exposures.

42. The system according to claim 40, wherein the computer is programmed to determine a phenotypic expression of the patient data.

43. A system for determining a phenotypic expression of a patient having a genetic predisposition for disease, the system comprising:
at least one hospital having a first database for storing local disease outcomes information;
a vendor having a second database, where the second database is interconnected to the first database, the second database for storing patient data collected from the at least one hospital; and
a computer programmed to anonymize and aggregate the patient data, where the second database is accessible by third party users.
